(19) United States
(12) Patent Application Publication
(10) Pub. No.: US 2011/0286148 A1
(43) Pub. Date: Nov. 24, 2011

(54) Electrochemical device and method for manufacturing the same

(75) Inventors: Sang Kyun Lee, Suwon (KR); Bae Kyun Kim, Seongnam (KR); Chang Ryul Jung, Seoul (KR); Yeong Su Cho, Guri (KR)

(73) Assignee: SAMSUNG ELECTRO-MECHANICS CO., LTD., Suwon (KR)

(21) Appl. No.: 12/923,904

(22) Filed: Oct. 13, 2010

(30) Foreign Application Priority Data
May 20, 2010 (KR) 10-2010-0047518

(51) Int. Cl. H01G 9/155; H01G 9/15; H01G 7/00

(52) U.S. Cl. 361/502; 29/25.42; 361/523

(57) ABSTRACT

There is provided an electrochemical device and a method for manufacturing the same. The electrochemical device includes: a collector that includes first and second electrodes disposed opposite to each other and an ion transmittable separator disposed therebetween; and a fixing member that surrounds the external surface of the collector and fixes the collector by bending parts formed at both ends. The electrochemical device can minimize the movement of the collector and maximize the overlapping portion between the first and second electrodes, thereby having excellent capacity.

### CROSS-REFERENCE TO RELATED APPLICATIONS

This application claims the priority of Korean Patent Application No. 10-2010-0047518 filed on May 20, 2010, in the Korean Intellectual Property Office, the disclosure of which is incorporated herein by reference.

### BACKGROUND OF THE INVENTION

1. Field of the Invention

The present invention relates to an electrochemical device and a method for manufacturing the same, and more particularly, to an electrochemical device having low resistance and excellent capacity and a method for manufacturing the same.

2. Description of the Related Art

A stable supply of energy has been important factor in various electronic products such as information communications and technology equipment. Generally, such a function is performed by a capacitor. In other words, the capacitor serves to store and supply electricity within the circuits of information and communications technology equipment and various electronic products, thereby stabilizing a flow of electricity through circuits. A general capacitor has a very short charging/discharging time, a long life span, and a high output density, but has a low energy density. Therefore, it has limited applications as a storage apparatus.

In order to overcome such a limitation, a capacitor falling into a new category such as an electric double layer capacitor having a short charging/discharging time and a high output density has been recently developed and the main focus thereon has been as a next generation energy storage apparatus, as well as a secondary battery.

The electric double layer capacitor, which is an energy storage apparatus using a pair of electrodes having different polarities, can be continuously charged and discharged. The electric double layer capacitor has high energy efficiency and high energy output as well as excellent durability and stability as compared to other general capacitors. Therefore, an electric double layer capacitor that can be charged with and can discharge a large current has recently been promising as a power storage apparatus which may be frequently charged and discharged, such as an auxiliary power source for a cellular phone, an auxiliary power source for an electric vehicle, an auxiliary power source for a solar cell, or the like.

The electric double layer capacitor is basically configured of an electrode having a relatively large surface area such as a porous electrode, an electrolyte, a current collector, and a separator. The principle on which the electric double layer capacitor is operated is based on an electrochemical mechanism, in that as several volts of voltage are applied across a unit cell electrode, ions in the electrolyte move by an electric field to be attracted on the surface of the electrode.

In addition, various kinds of electrochemical devices operating via a principle similar to the electric double layer capacitor have been developed.

### SUMMARY OF THE INVENTION

An aspect of the present invention provides an electrochemical device having low resistance and excellent capacity and a method for manufacturing the same.

According to an aspect of the present invention, there is provided an electrochemical device, including: a collector that includes first and second electrodes disposed opposite to each other and an ion transmittable separator disposed therebetween; and a fixing member that surrounds the external surface of the collector and fixes the collector by bending parts formed at both ends thereof.

The fixing member may not surround a portion of the external surface of the collector and may have the bending parts formed on the portion.

The fixing member may be made of a metallic material and the metallic material may be coated with an insulating layer.

The fixing member may be made of a wire having a circular cross-section.

The collector may be formed by stacking a plurality of unit cells, each unit cell including first and second electrodes and a separator formed therebetween.

According to another aspect of the present invention, there is provided an electrochemical device, including: a collector formed by stacking a plurality of unit cells, each unit cell including first and second current collectors having first and second terminal drawing parts, first and second electrodes formed on the first and second current collectors, and an ion transmittable separator disposed between the first and second electrodes; and a fixing member that surrounds an external surface of at least one of the plurality of first terminal drawing parts and the plurality of second terminal drawing parts and fixes at least one of the plurality of first terminal drawing parts and the plurality of second terminal drawing parts with bending parts formed at both ends thereof.

The fixing member may not surround a portion of an external surface of at least one of the plurality of first terminal drawing parts and the plurality of second terminal drawing parts but may have the bending parts formed on the portion.

The fixing member may be made of the same material as the first or second current collector.

The fixing member may be made of a metallic material.

The fixing member may be made of a wire having a circular cross-section.

The electrochemical device may further include a fixing member that surrounds an external surface of the collector and fixes the collector with the bending parts formed at both ends thereof.

According to another aspect of the present invention, there is provided a method for manufacturing an electrochemical device, including: preparing a collector that has first and second electrodes disposed opposite to each other and an ion transmittable separator disposed therebetween; disposing the collector on a table in which inserting grooves are formed; disposing a fixing member on the collector; and bending both ends of the fixing member by the inserting grooves by pressurizing the fixing member and fixing the collector.

The collector may be formed by stacking a plurality of unit cells, each unit cell including first and second electrodes and a separator formed therebetween.

The fixing member may have a structure formed so a not to surround a portion of the external surface of the collector and may have bending parts formed at both ends thereof on the portion by the pressurization.

According to another aspect of the present invention, there is provided a method for manufacturing an electrochemical device, including: preparing a collector formed by stacking a plurality of unit cells, each unit cell including first and second current collectors having first and second terminal drawing parts, first and second electrodes formed on the first and second current collectors, and an ion transmittable separator disposed between the first and second electrodes; disposing at least any one of the plurality of first terminal drawing parts and the plurality of second terminal drawing parts on a table in which inserting grooves are formed; disposing a fixing member on at least one of the plurality of first terminal drawing parts and the plurality of second terminal drawing parts; and bending both ends of the fixing member by the inserting grooves by pressurizing the fixing member and fixing at least any one of the plurality of first terminal drawing parts and the plurality of second terminal drawing parts.

The fixing member may have a structure formed so as not to surround a portion of the external surface of at least one of the plurality of first terminal drawing parts and the plurality of second terminal drawing parts and may have bending parts formed at both ends thereof on the portion by the pressurization.

The method for manufacturing an electrochemical device may further include forming a fixing member that surrounds the external surface of the collector and fixes the collector with the bending parts formed at both ends thereof.

### BRIEF DESCRIPTION OF THE DRAWINGS

The above and other aspects, features and advantages of the present invention will be more clearly understood from the following detailed description taken in conjunction with the accompanying drawings, in which:

FIG. 1A is a schematic perspective view showing an electric double layer capacitor according to an exemplary embodiment of the present invention, and FIG. 1B is a schematic cross-sectional view showing the electric double layer capacitor taken along line I-I′ of FIG. 1A; and

FIG. 2A is a schematic cross-sectional view showing an electric double layer capacitor according to an exemplary embodiment of the present invention, and FIG. 2B is a partial cross-sectional view showing the terminal drawing part of the electric double layer capacitor of FIG. 2A; and

FIGS. 3A through 3D are schematic process cross-sectional views showing a method for manufacturing an electric double layer capacitor according to an exemplary embodiment of the present invention.

### DETAILED DESCRIPTION OF THE PREFERRED EMBODIMENT

Exemplary embodiments of the present invention will now be described in detail with reference to the accompanying drawings. The exemplary embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

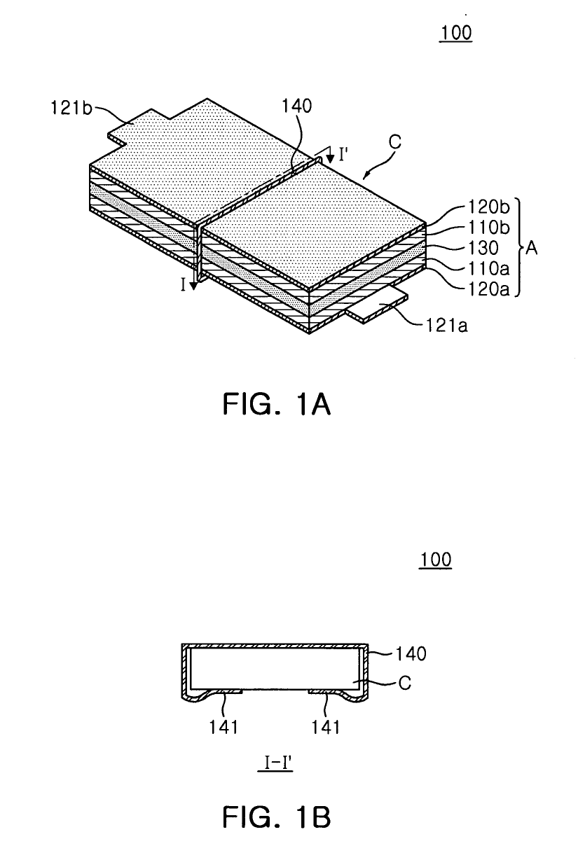

An electric double layer capacitor, an example of an electrochemical device of the present invention, will be described with reference to FIGS. 1A and 1B. FIG. 1A is a schematic perspective view showing an electric double layer capacitor according to an exemplary embodiment of the present invention, and FIG. 1B is a schematic cross-sectional view showing the electric double layer capacitor taken along line I-I′ of FIG. 1A.

Referring to FIGS. 1A and 1B, an electric double layer capacitor 100 according to the present embodiment includes a collector C and a fixing member 140 that surrounds the collector.

The collector C includes first and second electrodes 110a and 110b that are disposed opposite to each other and an ion transmittable separator 130 that is disposed therebetween.

The first and second electrodes 110a and 110b are disposed opposite to each other and electricity having different polarities is applied thereto. The first and second electrodes 110a and 110b may be made of a polarizable electrode material, for example, activated carbon having a relatively high specific surface area, or the like.

First and second current collectors 120a and 102b may be formed on external surface of the first and second electrodes 110a and 110b, respectively. The first and second current collectors 120a and 120b, each of which are conductive sheets for transferring electrical signals to the first and second electrodes 110a and 110b, may be made of a conductive polymer, a rubber sheet, or a metallic foil.

The polarizable electrode material is applied and fixed to the first and second current collectors 120a and 120b, thereby making it possible to form the first and second electrodes 110a and 110b. The first and second current collectors 120a and 120b may have first and second terminal drawing parts 121a and 121b in which an electrode material is not formed.

The shape of the first and second terminal drawing parts 121a and 121b may be varied properly so as to be connected to an external terminal (not shown) that transfers an electrical signal to the electric double layer capacitor. As shown in the present embodiment, the first and second terminal drawing parts 121a and 121b may be formed on surfaces of the collector, opposite to each other. However, they are not limited thereto and may be formed so as not to overlap on the same surface of the collector.

In addition, when the first and second current collectors 120a and 120b are not included, the electrode material is manufactured as a sheet in a solid state, thereby making it possible to manufacture the first and second electrodes.

The separator 130 may be made of a porous material so that ions can be transmitted therethrough. However, the separator 130 is not limited thereto but may be made of polypropylene, polyethelene, a glass fiber or the like by way of example of the porous material.

The fixing member 140 surrounds the external surface of the collector. The collector C is fixed by the fixing member 140. As shown in FIG. 1B, bending parts 141 are formed at both ends of the fixing member 140.

The fixing member 140 surrounds the external surface of the collector C, wherein both ends of the fixing member reaching a portion of the collector are bent to fix the collector.

As shown in the figure, both ends of the fixing member 140 may reach the portion, not surrounding a portion of the external surface of the collector. The bending parts 141 are formed at both ends of the fixing member reaching the portion, such that the collector may be fixed by the bending parts.

In general, an electric double layer capacitor is electrically connected to an external terminal applying electricity to a collector through a package process.

In the electric double layer capacitor, according to electricity applied, ions in an electrolyte move along an electric field to be attracted to the surface of the electrode and energy density is determined according to the amount of the ions attracted thereto. In order to increase the energy density, it is preferable that an overlapping portion between the two electrodes is maximized and movements of the ion transmittable separator and the electrodes are minimized during the stacking process of the first and second electrodes and the ion transmittable separator and the package process.

According to the present embodiment, the fixing member is used, thereby making it possible to maximize the overlapping portion between the two electrodes of the collector and minimize the movements of the ion transmittable separator and the electrodes.

The fixing member 140 may be made of a material having an appropriate strength but being easily shaped by pressurization, so that the changed shape can be maintained for a long period of time. The fixing member 140 may be a metallic material such as aluminum, copper, or the like.

In the present embodiment, an insulating layer may be formed on the metallic material in order to prevent an electrical short-circuit.

In addition, although not shown, the fixing member 140 may be configured in plural. When the fixing member is configured in plural, positions in which each fixing member is formed may be properly selected in order to minimize the movement of the collector.

In addition, the fixing member 140 is not limited thereto but may be made of a wire having a circular cross-section. In this case, the fixing member 140 occupies a small area in the collector, thereby making it possible to reduce an area in which an infiltration of the electrolyte is interrupted.

A plurality of unit cells may be stacked in order to obtain much higher electric capacity in the electric double layer capacitor. A unit cell A may be configured of first and second electrodes 110a and 110b and a single separator 130, and include first and second current collectors 120a and 102b formed each on the external surface of the first and second electrodes 110a and 110b.

Even though the present embodiment describes the collector C as the unit cell A, it is not limited thereto, and the collector C may be formed by stacking a plurality of unit cells.

When the plurality of unit cells A are stacked, the movement of the collector can be minimized and the overlapping portion between the first and second electrodes can be maximized by the fixing member.

Various electrochemical devices according to the present invention may be a pseudo capacitor, a hybrid capacitor, a lithium ion capacitor or the like. The electrochemical devices may be applied by properly changing the configuration of the collector.

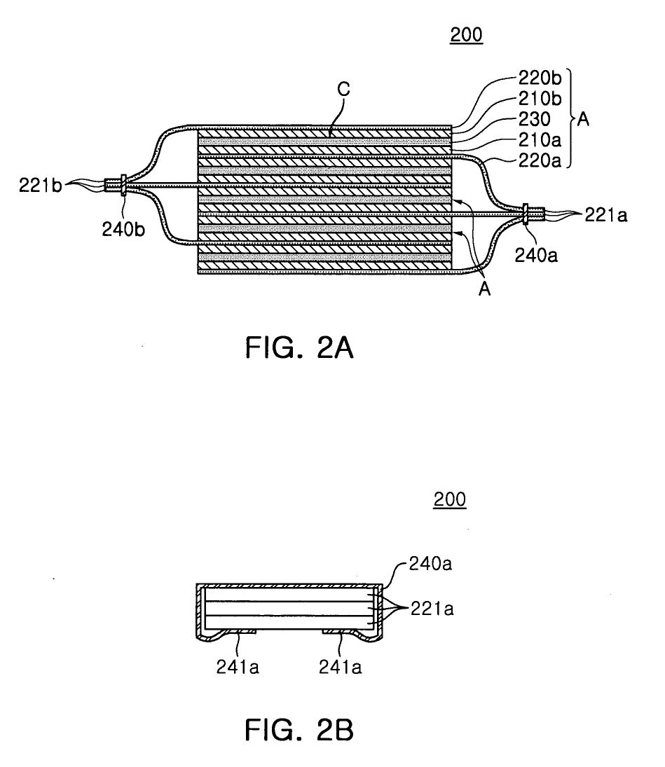

FIGS. 2A and 2B show an electric double layer capacitor that is an example according to another embodiment of the present invention: FIG. 2A is a schematic cross-sectional view showing an electric double layer capacitor according to the embodiment of the present invention, and FIG. 2B is a partial cross-sectional view showing the terminal drawing part of the electric double layer capacitor of FIG. 2A. This will be described based on constituents different from those in the aforementioned embodiment and a detailed description of the same constituents will be omitted.

Referring to FIGS. 2A and 2B, an electric double layer capacitor 200 according to the present embodiment includes a collector C in which a plurality of unit cells A are stacked.

The unit cell A includes first and second electrodes 210a and 210b that are disposed opposite to each other and an ion transmittable separator 230 that is disposed therebetween.

The first and second electrodes 210a and 210b are formed on first and second current collectors 220a and 220b, respectively. The first and second current collectors 220a and 220b, each of which are conductive sheets for transferring electrical signals to the first and second electrodes, may be made of a conductive polymer, a rubber sheet, or a metallic foil.

The first and second current collectors 220a and 220b have first and second terminal drawing units 221a and 221b in which an electrode material is not formed.

The shape of the first and second terminal drawing units 221a and 221b may be varied properly so as to be connected to an external terminal (not shown) that transfers an electrical signal to the electric double layer capacitor. As shown in the present embodiment, the first and second terminal drawing parts 221a and 221b may be formed on surfaces of the collector, opposite to each other. However, they are not limited thereto but may be formed on the same surface of the collector, not overlapping each other.

The first fixing member 240a is formed to surround the external surface of the plurality of first terminal drawing parts 221a. The first fixing member 240a gathers the plurality of first terminal drawing parts. 221a into one and surrounds the external surface of the plurality of first terminal drawing parts 221a gathered into one, wherein both ends of the first fixing member 240a reaching a portion of the external surface are bent to fix the plurality of first terminal drawing parts 221a.

As shown in the figure, both ends of the first fixing member 240a may reach the portion, not surrounding a portion of the external surface of the first terminal drawing part 221a gathered into one. Bending parts 241a are formed at both ends of the fixing member reaching the portion and the plurality of first terminal drawing parts 221a may be fixed by the bending parts 241a.

In addition, a second fixing member 240b that gathers a plurality of terminal drawing parts 221b into one and surrounds the external surface of the plurality of second terminal drawing parts 221b gathered into one may be formed.

In general, an electric double layer capacitor is electrically connected to an external terminal applying electricity to a collector through a package process.

In this configuration, first and second terminal drawing parts are connected to the external terminal. The first and second terminal drawing parts may be connected to the external terminal by ultrasonic fusion, laser bonding, or the like.

According to the present embodiment, the plurality of terminal drawing parts are fixed into one to facilitate a connection process with the external terminal. It is possible to prevent the terminal drawing part from being torn or a fusion malfunction from being generated during the connection process, thereby making it possible to solve the problem that resistance is increased.

In addition, it is possible to minimize the movement of the collector and maximize the overlapping portion between the first and second electrodes.

The first and second fixing members 240a and 240b may be made of a material having an appropriate strength and being easily shaped by pressurization, so that the changed shape can be maintained for a long period of time. The first and second fixing members may use the same material as the first and second current collectors, for example, a metallic material such as aluminum, copper, or the like.

In addition, although not shown, the first and second fixing members 240a and 240b may also be configured in plural. When the first and second fixing members 240a and 240b are configured in plural, the positions in which each fixing member is formed may be selected properly so as to minimize the movement of the first and second terminal drawing parts.

In addition, the first and second fixing members 240a and 240b are not limited thereto but may be made of a wire having a circular cross-section. In this case, the first and second fixing members 240a and 240b occupy small areas in the terminal drawing part, thereby making it possible to facilitate the connection with the external terminal.

In addition, although not shown, a fixing member may be additionally formed on the external surface of the collector C. The fixing member formed on the external surface of the collector may surround the external surface of the collector and may fix the collector with the bending parts formed at both ends thereof as described with reference to FIGS. 1A and 1B.

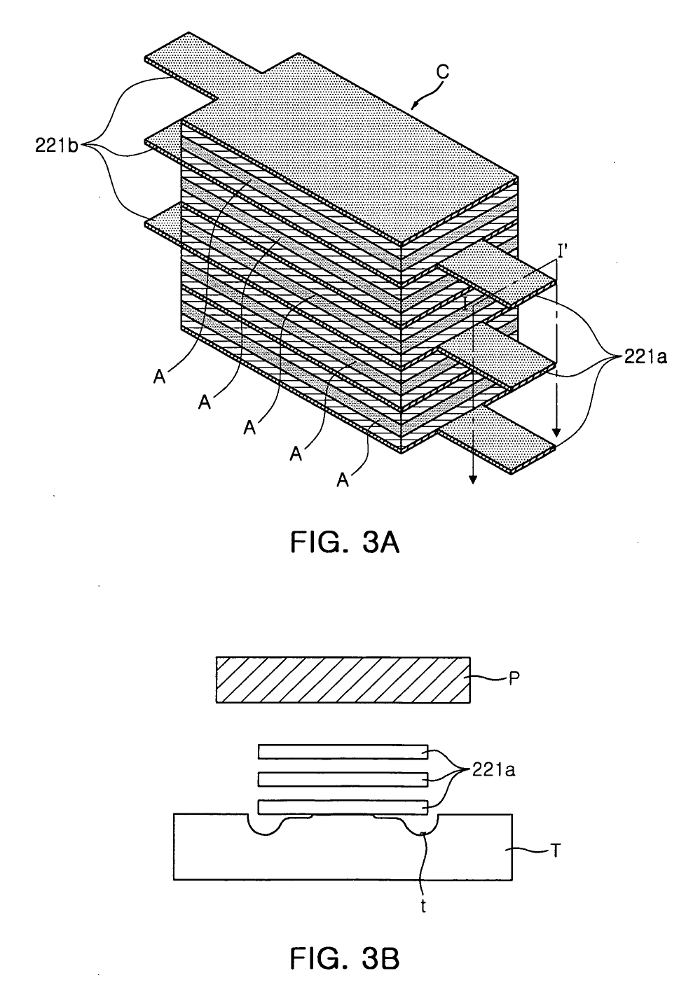

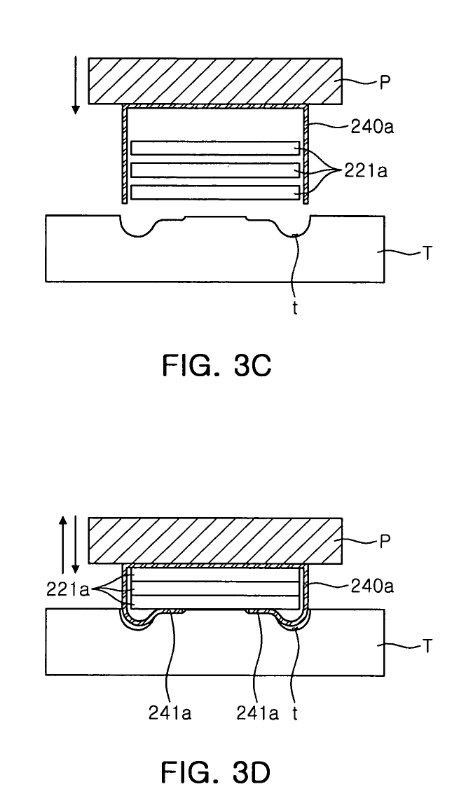

FIGS. 3A through 3D are schematic process cross-sectional views showing a method for manufacturing an electric double layer capacitor according to an exemplary embodiment of the present invention. FIGS. 3A to 3D show a method for manufacturing the electric double layer capacitor of FIGS. 2A and 2B.

First, as shown in FIG. 3A, a collector C is provided by stacking a plurality of unit cells A.

The unit cell A includes first and second electrodes disposed opposite to each other and an ion transmittable separator disposed therebetween. First and second current collectors may be formed on external surface of the first and second electrodes, respectively. The first and second current collectors have first and second terminal drawing parts 221a and 221b in which an electrode material is not formed.

Next, as shown in FIG. 3B, the collector is disposed on a table. A fixing member inserting groove t is formed in the table T and the plurality of first terminal drawing parts 221a on which the fixing member is to be formed are disposed on the position in which the inserting groove t is formed.

Next, as shown in FIG. 3C, a first fixing member 240a is disposed on the plurality of first terminal drawing parts 221a. The first terminal drawing parts 221a show a cross-section taken along line I-I′ of FIG. 3B.

Thereafter, a pressurizer P moves downward to apply press to the first fixing member 240a. Thereby, the plurality of first drawing parts 221a are gathered into one and the first fixing member 240a has bending parts 241a formed at both ends thereof by the inserting groove t of the table T. The plurality of first drawing parts 221a are fixed by the bending parts 241a.

The first fixing member 240a may have a structure to surround the external surface of the plurality of first terminal drawing parts 221a to be fixed but not to surround a portion of the external surface of the plurality of first terminal drawing parts 221a. Both ends of the first fixing member 240a are bent on the portion, thereby fixing the plurality of first terminal drawing parts 221a by the bending parts 241a.

As described above, the fixing member 240a may be made of a material having an appropriate strength and being easily shaped by pressurization, so that the changed shape can be maintained for a long period of time. The pressure applied by the pressurizer P may be controlled to have an appropriate magnitude capable of changing the shape of the first fixing member 240a.

In addition, the shape of the inserting groove t formed in the table T may be properly controlled so that both ends of the first fixing member 240a are bent toward the portion of the first terminal drawing part.

In addition, although not shown, even when the collector is disposed on the inserting groove t of the table T and the fixing member is formed on the collector, it is possible to manufacture the electric double layer capacitor as shown in FIGS. 1A and 1b.

In addition, the collector may be formed by stacking a plurality of unit cells each configured of first and second electrodes and a single separator.

As set forth above, according to exemplary embodiments of the invention, the plurality of terminal drawing parts are fixed into one to facilitate a process to connect the collector configuring the electric double layer capacitor to the external terminal. It is possible to prevent the terminal drawing part from being torn or a fusion malfunction from being generated during the connection process, thereby making it possible to solve the problem that resistance is increased.

In addition, it is possible to minimize the movement of the collector and maximize the overlapping portion between the first and second electrodes, thereby making it possible to increase capacity.

While the present invention has been shown and described in connection with the exemplary embodiments, it will be apparent to those in the art that modifications and variations can be made without departing from the spirit and scope of the invention as defined by the appended claims.

What is claimed is:

1. An electrochemical device, comprising:
a collector that includes first and second electrodes disposed opposite to each other and an ion transmittable separator disposed therebetween; and
a fixing member that surrounds the external surface of the collector and fixes the collector by bending parts formed at both ends thereof.

2. The electrochemical device of claim 1, wherein the fixing member does not surround a portion of the external surface of the collector and has the bending parts formed on the portion.

3. The electrochemical device of claim 1, wherein the fixing member is made of a metallic material and the metallic material is coated with an insulating layer.

4. The electrochemical device of claim 1, wherein the fixing member is made of a wire having a circular cross-section.

5. The electrochemical device of claim 1, wherein the collector is formed by stacking a plurality of unit cells, each unit cell including first and second electrodes and a separator formed therebetween.

6. An electrochemical device, comprising:
a collector formed by stacking a plurality of unit cells, each unit cell including first and second current collectors having first and second terminal drawing parts, first and second electrodes formed on the first and second current collectors, and an ion transmittable separator disposed between the first and second electrodes; and
a fixing member that surrounds an external surface of at least one of the plurality of first terminal drawing parts and the plurality of second terminal drawing parts and fixes at least one of the plurality of first terminal drawing parts and the plurality of second terminal drawing parts with bending parts formed at both ends thereof.

7. The electrochemical device of claim 6, wherein the fixing member does not surround a portion of an external surface of at least one of the plurality of first terminal drawing parts and the plurality of second terminal drawing parts but has the bending parts formed on the portion.

8. The electrochemical device of claim 6, wherein the fixing member is made of the same material as the first or second current collector.

9. The electrochemical device of claim 6, wherein the fixing member is made of a metallic material.

10. The electrochemical device of claim 6, wherein the fixing member is made of a wire having a circular cross-section.

11. The electrochemical device of claim 6, further comprising a fixing member that surrounds an external surface of the collector and fixes the collector with the bending parts formed at both ends thereof.

12. A method for manufacturing an electrochemical device, comprising:
preparing a collector that has first and second electrodes disposed opposite to each other and an ion transmittable separator disposed therebetween;
disposing the collector on a table in which inserting grooves are formed;
disposing a fixing member on the collector; and
bending both ends of the fixing member by the inserting grooves by pressurizing the fixing member and fixing the collector.

13. The method for manufacturing an electrochemical device of claim 12, wherein the collector is formed by stacking a plurality of unit cells, each unit cell including first and second electrodes and a separator formed therebetween.

14. The method for manufacturing an electrochemical device of claim 12, wherein the fixing member has a structure formed so as not to surround a portion of the external surface of the collector and has bending parts formed at both ends thereof on the portion by the pressurization.

15. A method for manufacturing an electrochemical device, comprising:
preparing a collector formed by stacking a plurality of unit cells, each unit cell including first and second current collectors having first and second terminal drawing parts, first and second electrodes formed on the first and second current collectors, and an ion transmittable separator disposed between the first and second electrodes;
disposing at least any one of the plurality of first terminal drawing parts and the plurality of second terminal drawing parts on a table in which inserting grooves are formed;
disposing a fixing member on at least one of the plurality of first terminal drawing parts and the plurality of second terminal drawing parts; and
bending both ends of the fixing member by the inserting grooves by pressurizing the fixing member and fixing at least any one of the plurality of first terminal drawing parts and the plurality of second terminal drawing parts.

16. The method for manufacturing an electrochemical device of claim 15, wherein the fixing member has a structure formed so as not to surround a portion of the external surface of at least one of the plurality of first terminal drawing parts and the plurality of second terminal drawing parts and has bending parts formed at both ends thereof on the portion by the pressurization.

17. The method for manufacturing an electrochemical device of claim 15, further comprising forming a fixing member that surrounds the external surface of the collector and fixes the collector with the bending parts formed at both ends thereof.
